(19) United States
(12) Patent Application Publication
(10) Pub. No.: US 2018/0245384 A1
(43) Pub. Date: Aug. 30, 2018

(54) DOUBLE THROW WINDOW LOCK

(71) Applicant: Randall L. SHIPLEY, Sherwood, OR (US)

(72) Inventor: Randall L. SHIPLEY, Sherwood, OR (US)

(21) Appl. No.: 15/442,446

(22) Filed: Feb. 24, 2017

(51) Int. Cl. E05C 9/04; E05C 9/00

(52) U.S. Cl. CPC E05C 9/041; E05C 9/00

(57) ABSTRACT

An apparatus for securing or locking a sliding window or door in one or more positions along a window or door track associated with an outer window or door frame. The apparatus may include a pinion gear, rotatable by a knob, operatively connected to two pins such that the rotation of the pinion gear causes the pins to move in an out of wells in the outer frame, based on the direction of rotation.

### BACKGROUND OF THE INVENTION

The subject matter of this application relates to a locking apparatus to be used with sliding windows or doors. In the field of construction of homes, commercial buildings, and similar structures, there has been a great increase in recent years in the use of windows and doors which employ sliding panels. It has been recognized that a need exists for a technique for locking sliding doors and windows in a partially open position. Sliding windows and sliding glass doors are traditionally made to only lock in a closed position. This does not protect against intruders with a partially open window, nor does it prevent accidental closures that may cause harm to small children.

Sliding windows or doors usually include a pair of parallel, spaced apart, horizontal channel members, each having a track therein which receives the window or vent panel and permit them to be slidably and horizontally translated.

Dowels or segments of wood have been used to keep a window or door in a partially-open position by lodging them between the window sash and the frame. In practice, various-lengthed poles are required depending on the desired position of the open window because such dowels are not adjustable. Such structures have proven partially effective for laterally-sliding windows and doors, but are ineffective because they lack the security of a lock. Prior locks suffer other disadvantages such as difficulty to install and, in some cases, insecure mounting. A further problem is that of adapting such locks to suit frames of various styles and sections.

Many of the lock units which require the proper keys for opening are a safety hazard in an emergency, in that they do not permit egress without the use of the proper key. During fires or similar emergencies, the time wasted unlocking a key-locked sliding window may determine the difference between escape and injury or death.

### SUMMARY OF THE INVENTION

The present invention relates to an apparatus for securing or locking a sliding window or door in one or more positions along a window or door track associated with an outer window or door frame. Such an apparatus allows for a user to select a position at which their window is locked at and wherein the locking component is sufficiently far away from the opening side of a window to minimize the ability of unauthorized opening by reaching in through the open window. In addition, the locking apparatus may be configured to be used with already-existing sliding window and door systems.

### BRIEF DESCRIPTION OF THE DRAWINGS

For a better understanding of the invention, and to show how the same may be carried into effect, reference will now be made, by way of example, to the accompanying drawings, in which:

FIG. 1 is an isometric view of the locking apparatus.

FIG. 2 is an elevational view of the locking apparatus, shown in FIG. 1, secured to the sliding window and locked with respect to the other frame.

FIG. 3 is an elevational view of the locking apparatus secured to the sliding window and moveable with respect to the outer frame.

### DETAILED DESCRIPTION

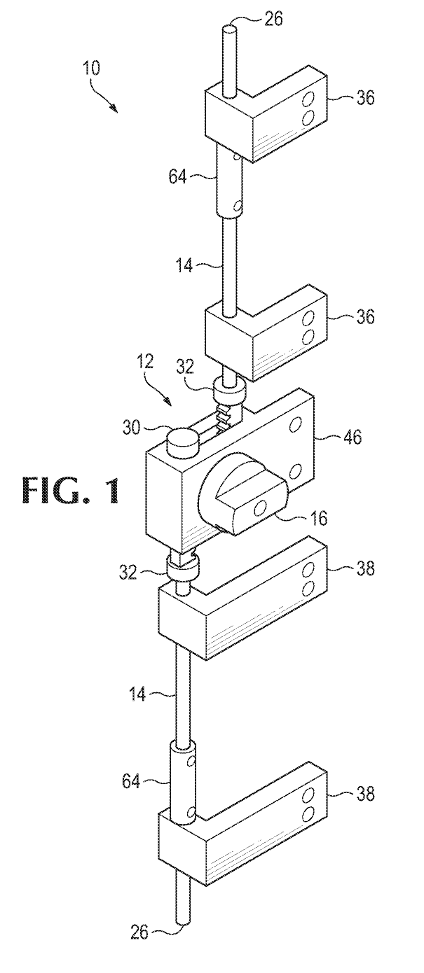

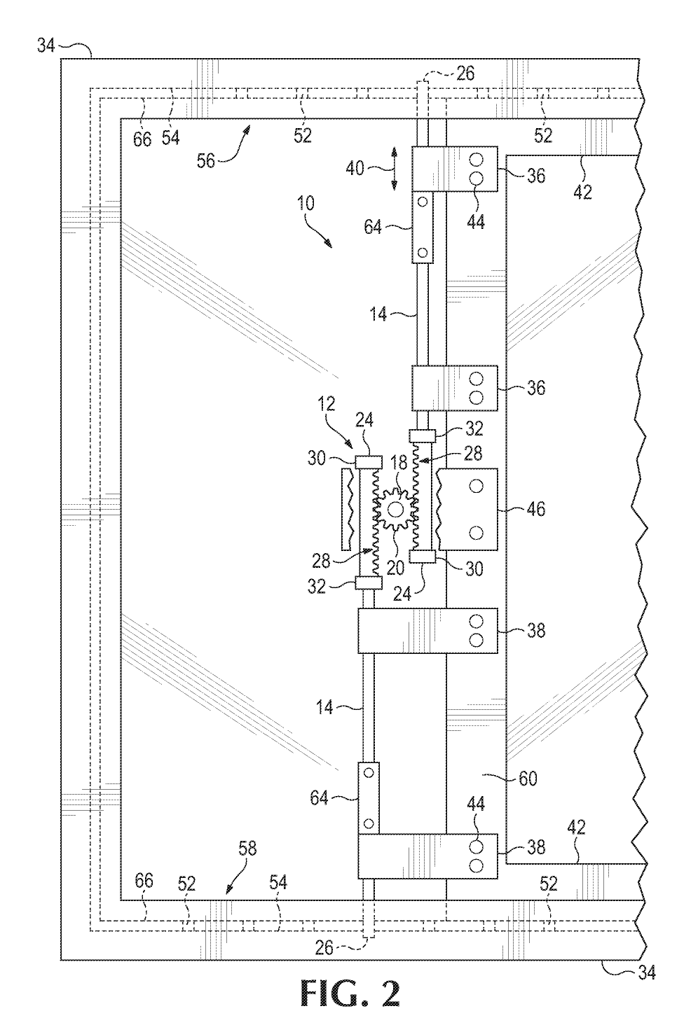

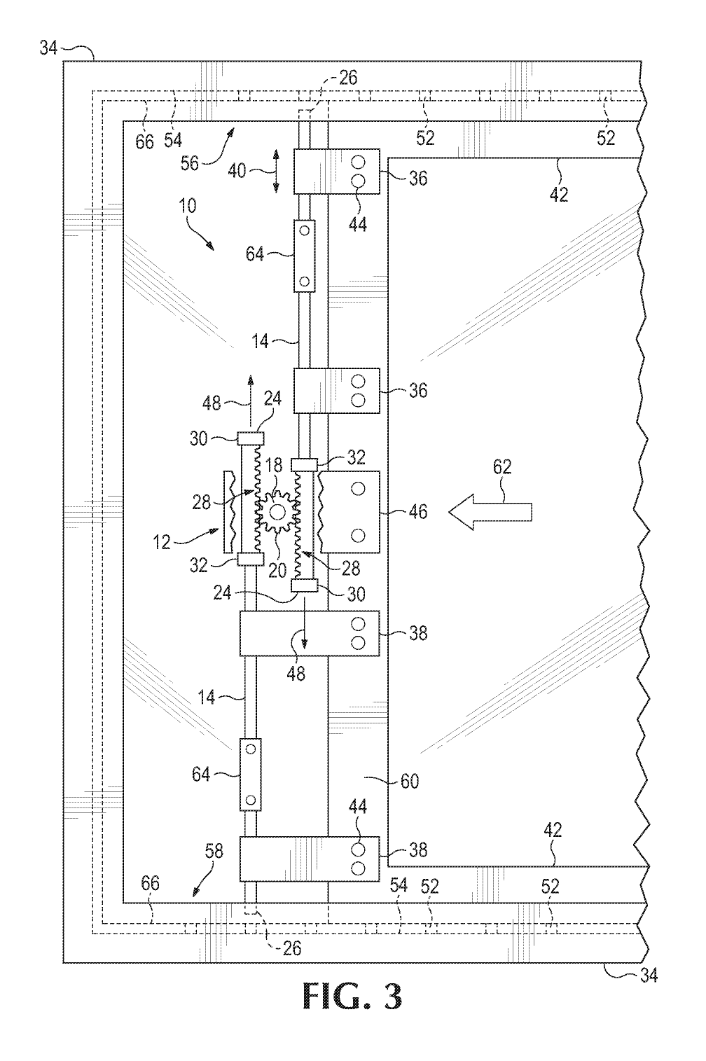

FIG. 1 shows an embodiment of the locking apparatus 10 and FIGS. 2 and 3 shows embodiments of the locking apparatus 10 secured to a sliding window frame 42. The locking apparatus 10, as shown in FIGS. 1, 2, and 3, includes a rack and pinion gear system 12 and double “throws” or pins 14. The gear system 12 may be actuated with a rotatable knob 16 or any other device, attached or attachable to the pinion gear 18, such that the knob 16 functions to rotate the pinion gear 18.

The pinion gear 18 may have teeth 20 configured to fit within associated set of pin teeth 28, as best viewable in FIGS. 2 and 3. Each pin 14 may have a first end 24 and a second end 26. The first end 24 of each pin 14 has a set of teeth 28 that may have first and second stoppers 30, 32 on each end of the set of teeth 28. The stoppers 30, 32 may function to limit lateral translation of the pins 14 as the pinion gear 18 is rotated to prevent translation of the pins 14 that go beyond the sets of respective teeth 28.

The second end of each pin 26 may be selectively engageable with the associated outer window frame 34 such that a user may use the gear system 12 to selectively move the pins 14 to position the pins into wells 52 located within the associated frame 34, as will be described in more detail below.

FIGS. 2 and 3 show an embodiment of the locking apparatus 10 in use with an outer window or door frame 34 and an inner sliding window or door frame 42. The apparatus may have one or more securement flanges 36, 38 which function to hold a portion of a respective pin 14, while allowing the respective held pin 14 to slide up and down (arrow 40), and to secure the pin 14 to a frame of a sliding window or door 42, or to a first side of the sliding window 60. The flanges 36, 38 shown in one embodiment are L-shaped, however, in other embodiments, the flanges may take other functional shapes. The securement flanges 36, 38 may be secured to the frame 42 in any suitable manner. In one embodiment, threaded holes 44 are included in the securement flanges to support the use of screws (not shown) to attach the flanges to the frame 42. In one embodiment, two securement flanges 36, 38 are used for each pin 14 to secure the pins 14 to the window frame 42.

As best viewed in FIG. 1, the two pins 14 and the gear 18 are secured with an enclosing flange 46. Such an enclosing flange 46 holds the teeth 20 of the pinion gear in operative contact with the set of teeth 28 on each pin 14, such that when the pinion gear 18 is rotated in a clockwise direction, the pins 14 move in the direction of the arrows 48 shown in FIG. 3. When the pinion gear 18 is rotated in a counter clockwise direction, the pins 14 will move in the opposite direction of the arrows 48. The enclosing flange 46 also holds the knob 16, such that the knob 16 is connected to the pinion gear 18, to allow a user to effectively rotate the gear 18 by using the knob 16. The inside surface of the enclosing flange 46 also provides a sliding surface upon which the first end of the pins 24 may slide or move against as the pinion gear 18 is rotated and causes movement of the pins 14. In other embodiments, the positions of the pins 14 and the pinion gear 18 may be such the pinion gear 18 is rotated in the opposite directions to achieve the desired movements of the pins 14.

The pins 14 may also be constructed with respective stop blocks 64 that are attached to the pins 14 that prevent over extension of the second end of the pins 26 into the wells 52, as best shown in FIG. 2. Such prevention is effectuated by an end of a respective stop block 64 coming into contact with a side of a respective securement flange 36, 38.

In one embodiment, the outer window frame 34 includes at least one channel 66 having a track 54 which function together to contain the inner window frame 42 and allow the frame 42 to slide laterally back and forth between opened and closed positions. In the embodiment shown in FIGS. 2 and 3, the outer frame 34 has dual channels 66 and tracks 54 on the topside 56 and the bottom side 58 of the outer frame 34. To use the locking apparatus 10 with a sliding window or door, the outer frame 34 is configured to have a plurality of wells 52 extending into the frame track 54. The wells 52 should have a size that is large enough to accept the second end of the pins 26 when a user rotates the pinion gear 18, as shown in FIG. 2. In one embodiment, the wells 52 and the second end of the pins 26 are cylindrical, and the circumference of the wells 52 is greater than the circumference of the second end of the pins 26. The wells 52 should also have depth sufficient to retain the ends of the pins 26 in place to resist movement of the inner sliding window or door 42 once the pins 14 are secured in place.

The locations of the wells 52 within the tracks 54 depend on the horizontal distance between the dual pins 14. A well 52 in the top of the outer frame 56 should have a corresponding well 52 in the bottom of the outer frame 58 such that when a user wants to secure the sliding window or door 42 in position, both pins 14 may be received by wells 52 on either side of the outer frame 34. A user may also selectively position the wells 52 based on where the user wants the sliding window or door to be locked.

In use, an existing outer frame 34 may be retrofitted to include wells 52, as desired by a user, or an outer frame 34 may be manufactured with a plurality of wells 52 included within the outer frame 34. Similarly, the sliding frame 42 may be manufactured with the locking apparatus 10, or the locking apparatus 10 may be installed on an existing sliding window or door frame 42 by a user. In one embodiment, to install the locking apparatus 10, one end of each of the securement flanges 36, 38 is secured to a first side of the sliding window or door 60. A user may then secure the securement flanges 36, 38 and the enclosing flange 46 to the first side of the sliding window or door 60 with the use of screws (not shown) through the threaded holes 44. Further, the locking mechanism may be integrated within the housing surrounding the window or door.

Having such a locking apparatus 10 installed within a sliding window or door frame provides for facilitated locking at a variety of different positions of window or door opening. To unlock or move the sliding window, as represented by arrow 62 in FIG. 3, the knob 16 and therefore the pinon gear 18 should be moved in a clockwise direction, thereby retracting the pins 14 to allow unrestricted movement of the sliding window along the track 54. Once the user slides the window 42 to a desired position, the user may align the second end of the pins 26 with wells 52, and rotate the knob 16 in a counter clockwise position to extend the second ends of the pins 26 into the wells 52, such that the engagement of the pins 14 in the wells secure the sliding window or door 42 in position.

It will be appreciated that the invention is not restricted to the particular embodiments that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A locking apparatus for locking sliding windows or doors, said apparatus comprising:
a pinion gear operatively connected to dual pins such that rotation of said gear in a first direction causes at least one of said pins to secure the sliding window or door in a user-selected position.

2. The apparatus of claim 1 wherein said sliding door has an outer frame having at least one well, said well capable of receiving one end of one of said pins.

3. The apparatus of claim 2 wherein said outer frame has at least two holes, each hole capable of receiving an end of one of said pins.

4. The apparatus of claim 1 wherein rotation of said pinion gear functions to insert said dual pins into dual wells located in a window or door frame such that said insertion causes securement t of said apparatus in said user-selected position.

5. A locking apparatus for locking a sliding window or door, said window or door having an outer frame and an inner frame, said apparatus comprising:
a pinion gear and a knob attached to said pinion gear the functions to rotate said gear;
dual pins in contact with said pinion gear such that rotation of said pinion gear in a first direction moves an end of each pin into wells located in said outer frame, and rotation of said gear in a second direction retracts said ends out of said wells.

6. The apparatus of claim 5 wherein said dual pins have teeth that correspond to teeth on said pinion gear.

7. The apparatus of claim 5 wherein said pins are secured to said inner frame with at least one flange for each pin, such that each flange functions to allow movement of said pins.

8. The apparatus of claim 7 wherein said pinion gear and said knob are secured to said inner frame with an enclosing flange.
